(19) United States
(12) Patent Application Publication
(10) Pub. No.: US 2019/0200275 A1
(43) Pub. Date: Jun. 27, 2019

(54) SYSTEMS AND METHODS FOR PEER-TO-PEER DATA TRANSFER

(71) Applicant: Walmart Apollo, LLC, Bentonville, AR (US)

(72) Inventors: Richard M. Blair, II, Bentonville, AR (US); Eugene P. Sunday, Glen Ellyn, IL (US)

(21) Appl. No.: 16/229,729

(22) Filed: Dec. 21, 2018

Related U.S. Application Data
(60) Provisional application No. 62/609,734, filed on Dec. 22, 2017.

(51) Int. Cl. H04W 40/22; H04W 40/24; H04W 64/00; H04W 4/02

(52) U.S. Cl. CPC H04W 40/22; H04W 40/246; H04W 88/04; H04W 4/02; H04W 64/00

(57) ABSTRACT

In some embodiments, apparatuses and methods are provided herein useful to peer-to-peer data transmission. In some embodiments, a system for transmitting data from a first mobile device to an end location comprises the first mobile device, wherein the first mobile device comprises a wireless radio, a user input device, a display device, and a control circuit configured to receive a user command, select, based on information received from an application, the end location, wherein the end location is predicted to provide access to a wireless local area network, transmit, to other mobile device, a discovery message, receive, from the other mobile devices, responses, select, based on the end location and the location information, a second mobile device, and transmit, to the second mobile device, the data, and the second mobile device configured to select a third mobile device, and transmit, to the third mobile device, the data.

### CROSS-REFERENCE TO RELATED APPLICATION

This application claims the benefit of U.S. Provisional Application No. 62/609,734, filed Dec. 22, 2017, which is incorporated by reference in its entirety herein.

### TECHNICAL FIELD

This invention relates generally to data transmission and, more specifically, to peer-to-peer data transmission.

### BACKGROUND

Modern wireless wide area networks (WWANs) are quite robust, allowing customers to transmit and receive data seemingly everywhere. However, cellular carriers typically charge customers for the amount of data transferred (i.e., transmitted and received) over a WWAN. In some instances, the costs associated with transmitting and receiving data over a WWAN may prevent customers from fully utilizing the capabilities of their mobile device (e.g., smartphones, tablets, portable computers, etc.). To avoid these costs, many customers seek free wireless networks (e.g., free Wi-Fi hotspots) to which they can connect, limiting the amount of data transferred via the WWAN. While applications exist that compile lists of locations having free Wi-Fi, simply knowing that a location provides free Wi-Fi does not help customers who are not at these locations. That is, if a customer is not within range of a free Wi-Fi network, the existence of free Wi-Fi networks does not benefit the customer. Accordingly, a need exists for systems, methods, and apparatuses which allow customers to transmit data over a free wireless network while the customers are not directly connected to the free wireless network (e.g., when a customer is not within range of a free wireless network).

### BRIEF DESCRIPTION OF THE DRAWINGS

Disclosed herein are embodiments of systems, apparatuses, and methods pertaining to peer-to-peer data transmission. This description includes drawings, wherein:

FIG. 1 is a block diagram depicting the transmission of data in a peer-to-peer manner to make use of a free wireless network provided at an end location 122, according to some embodiments;

FIG. 2 is a block diagram of a system 200 for transmitting data from a first mobile device 202 in a peer-to-peer manner to make use of a free wireless network 220 at an end location, according to some embodiments; and

FIG. 3 is a flow chart depicting example operations for transmitting data from a first mobile device to an end location in a peer-to-peer manner, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to peer-to-peer data transmission. In some embodiments, a system for transmitting data from a first mobile device to an end location in a peer-to-peer manner comprises the first mobile device, wherein the first mobile device comprises a wireless radio, wherein the wireless radio is configured to transmit and receive data, a user input device, a display device, and a control circuit, wherein the control circuit is configured to receive, via the user input device, a user command to transmit data, select, based on information received from an application executing on the first mobile device, the end location, wherein the end location is predicted to provide access to a wireless local area network, wherein the wireless local area network is communicatively coupled to a wide area network, and wherein the access to the wireless local area network is provided without requiring payment for use of the local area network, transmit, via the wireless radio to other mobile device, a discovery message, receive, from at least some of the other mobile devices, responses, wherein the responses include location information for the at least some of the other mobile devices, select, from the other mobile device based on the end location and the location information for the at least some of the other mobile devices, a second mobile device, and transmit, to the second mobile device via the wireless radio, the data, and the second mobile device, wherein the second mobile device is configured to select, based on the end location after receipt of the data from the first mobile device, a third mobile device, and transmit, to the third mobile device, the data.

As previously discussed, wireless carriers often charge customer based on the amount of data they transmit and receive from their mobile devices (i.e., any electronic device connected to a wireless wide area network (WWAN)). The costs associated with the transfer of data over a WWAN can be significant enough that customers will seek alternative means for transferring data, such as a via a wireless local area network (WLAN—generically referred to as “Wi-Fi” herein) coupled to a wide area network (WAN). Specifically, customers will seek out WLANs which provide free access (i.e., WLANs that provide access without requiring payment for the use of the WLAN). By utilizing the WLAN, customer can transmit data over the WAN without incurring charges from a wireless carrier.

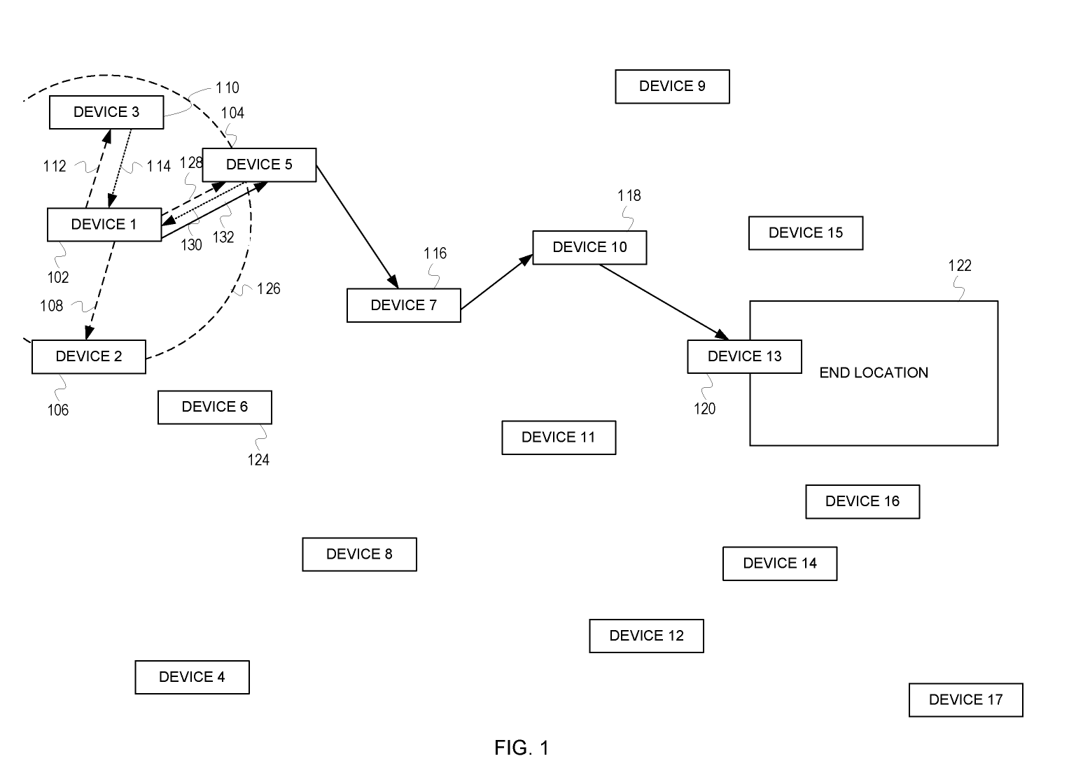

Embodiments, of the systems, methods, and apparatuses described herein allow customers to utilize such WLANs without having to connect directly to the WLAN. Accordingly, in some embodiments, customers can take advantage of transferring data over a WLAN communicatively coupled to a WAN without being within range of the WLAN. In one embodiment, customers can transfer data in a peer-to-peer manner until the data reaches an end device (i.e., a mobile device) connected to a WLAN. The end device then transfers the data over the WAN via the WLAN. If the customer is able to transfer the data to the end device without use of a WWAN (e.g., via near field communication (NFC) or other means), the customer can avoid the costs associated with the transfer of data over a WWAN. In some embodiments, a user's mobile device selects an end location based on the prediction that the end location provides free Wi-Fi access. Next, the user's mobile device determines to which mobile device(s) to transmit data, in an attempt to reach the end location. After the user's mobile device transmits the data to a second mobile device, the second mobile device continues the process by selecting a next mobile device to which to transmit the data. This process continues until the data reaches an end device that is connected to free Wi-Fi and the end device transmits the data via the free Wi-Fi. The discussion of FIG. 1 provides an overview of such a system.

FIG. 1 is a block diagram depicting the transmission of data in a peer-to-peer manner to make use of a free wireless network provided at an end location 122, according to some embodiments. The data transmission begins with a first mobile device 102 (i.e., “Device₁”). FIG. 1 depicts a plurality of mobile devices (i.e., Device₁ through Device₁₇). Each of the mobile devices can be any suitable type of device, such as a smartphone, a tablet, a computer, etc., and are not necessarily the same type of mobile device.

The data transmission is initiated by a command received via user input at the first mobile device 102. Upon receipt of the command, the first mobile device 102 selects an end location 122. The first mobile device 102 selects the end location 122 based on knowledge, or a prediction, that the end location 122 provides free Wi-Fi (e.g., a WLAN 124) coupled to a WAN 126. In some embodiments, the first mobile device 102 selects the end location 122 based on information received from an application executing on the first mobile device 102 (e.g., a third-party application). The application can be, for example, a mapping application or an application specifically designed to aid in finding free Wi-Fi (e.g., an application including a list of known locations with free Wi-Fi). In embodiments in which the application executing on the first mobile device 102 is specifically designed to aid in finding free Wi-Fi, the first mobile device 102 selects the end location 122 as the nearest, most convenient, quickest to get to, etc. location from the list. In embodiments in which the application running on the first mobile device 102 does not include a list of locations known to have free Wi-Fi (e.g., a mapping application) the first mobile device 102 can predict which locations are likely to have free Wi-Fi and select the end location 122 based on this prediction. In some embodiments, the first mobile device 102 makes predictions based on a type of establishment (e.g., a restaurant, a retail facility, a publicly owned facility, an educational facility, etc.). For example, if based on information received from a mapping application indicates that a coffee shop is located at the end location 122, the first mobile device may predict that the coffee shop is likely to provide free Wi-Fi and select the coffee shop as the end location 122. Additionally, the first mobile device 102 can consider a location of the end location 122 when selecting the end location. For example, the first mobile device 102 can select the end location 122 as the nearest, most convenient, quickest to get to, etc. location predicted to have free Wi-Fi access.

After selecting the end location 122, the first mobile device 102 must determine a path upon which the data should travel to reach the end location. In a first embodiment, the first mobile device 102 simply selects a next mobile device (i.e., a second mobile device) to which the data should be transmitted. In such embodiments, the first mobile device 102 transmits a discovery message. The discovery message can be a one-to-many message transmitted to all other mobile devices within range. In the diagram depicted in FIG. 1, this range is indicated by a dashed circle 126. The radius of this range is based on the technology employed to transmit the discovery message. If the discovery message is transmitted via Bluetooth, the radius of the range will be approximately thirty feet. As depicted in FIG. 1, three other mobile devices are within range of the first mobile device 102: a second mobile device 106 (i.e., Device₂), a third mobile device 110 (i.e., Device₃), and a fifth mobile device 104 (i.e., Device₅). The discovery message is transmitted to each of these three other mobile devices, as these three other mobile devices are within range of the discovery message. That is, the first mobile device 102 transmits the discovery message to the second mobile device 106, as indicated by a dashed arrow 108, the third mobile device 110, as indicated by a dashed arrow 112, and the fifth mobile device 104, as indicated by a dashed arrow 128. Other mobile devices depicted in FIG. 1, such as a sixth mobile device 124, do not receive the discovery message because they are out of range of the first mobile device 102.

The discovery message can be a simple inquiry requesting locations of other mobile devices. However, in some embodiments, the discovery message may include additional information. For example, the discovery message can include an identifier of the first mobile device 102, information about the data to be transferred (e.g., a description of the content of the data, an indication of the size of the data, an indication of an entity to whom the data will be transmitted, etc.), etc. Further, in some embodiments, the discovery message can include the data to be transmitted.

All, or some, of the three other mobile devices respond to the discovery message. Whether the other mobile devices respond to the discovery message may dependent upon whether the other mobile devices participate in the peer-to-peer data transmission system, the other mobile devices include a peer-to-peer data transmission application (whether generic or the same as a peer-to-peer data transmission application executing on the first mobile device 102), users of the other mobile devices allow for peer-to-peer data transmission (e.g., based on privacy settings), the content of the data to be transmitted, the size of the data to be transmitted, etc. In the example depicted in FIG. 1, the third mobile device 110 responded to the discovery message, as indicated by a dotted arrow 114, and the fifth mobile device 104 responded to the discovery message, as indicated by a dotted arrow 130. The responses can include information about the mobile device from which the response is sent. For example, the responses can include locations of the mobile devices transmitting the responses, identifiers of the mobile devices transmitting the responses, restrictions on data transmission of the mobile devices transmitting the responses, etc.

After receiving the responses from the other mobile devices, the first mobile device 102 selects a next mobile device to which the data should be transmitted. This selection can be based on a location of the next mobile device, the end location 122, restrictions on data transmission of the next mobile device, movement of the next mobile device (e.g., a next mobile device may be selected or omitted from selection based on its movement, direction of movement, speed, etc.), or any other suitable criteria. In the example depicted in FIG. 1, the first mobile device 102 selected the fifth mobile device 104 as the next mobile device. In this example, the first mobile device 102 selected the fifth mobile device 104 as the next mobile device, as of the other mobile devices that responded to the discovery message, the fifth mobile device 104 was nearest the end location 122.

The above-noted process continues with the fifth mobile device 104, and all subsequent “next” mobile devices until the data reaches a mobile device at the end location 122. In the example depicted in FIG. 1, the fifth mobile device 104 transmits the data to a seventh mobile device 116 (i.e., Device₇), the seventh mobile device 116 transmits the data to a tenth mobile device 118 (i.e., deviceio), and the tenth mobile device 118 transmits the data to a thirteenth mobile device 120 (i.e., Device 13). The thirteenth mobile device 120 is, or near enough the end location 122 to be connected to a wireless network provided, at the end location 122. The thirteenth mobile device 120 transmits the data via the wireless network provided by the end location 122.

In one embodiment, each “next” mobile device performs all of the steps of the first mobile device 102, including selecting an end location. That is, the fifth mobile device 104 selects the end location 122 (whether the same or different than the end location 122 selected by the first mobile device 102), transmits discovery messages, receive responses, select a next mobile device, and transmit the data). In other embodiments, the first mobile device 102 transmits an indication of the end location 122, as well as the data, to the fifth mobile device 104. In such embodiments, the fifth mobile device 104, as well as other subsequent “next” mobile devices, may not need to again select the end location 122. Additionally, some embodiments may employ both techniques. That is, some, but not all, of the mobile devices may select and/or reselect the end location 122.

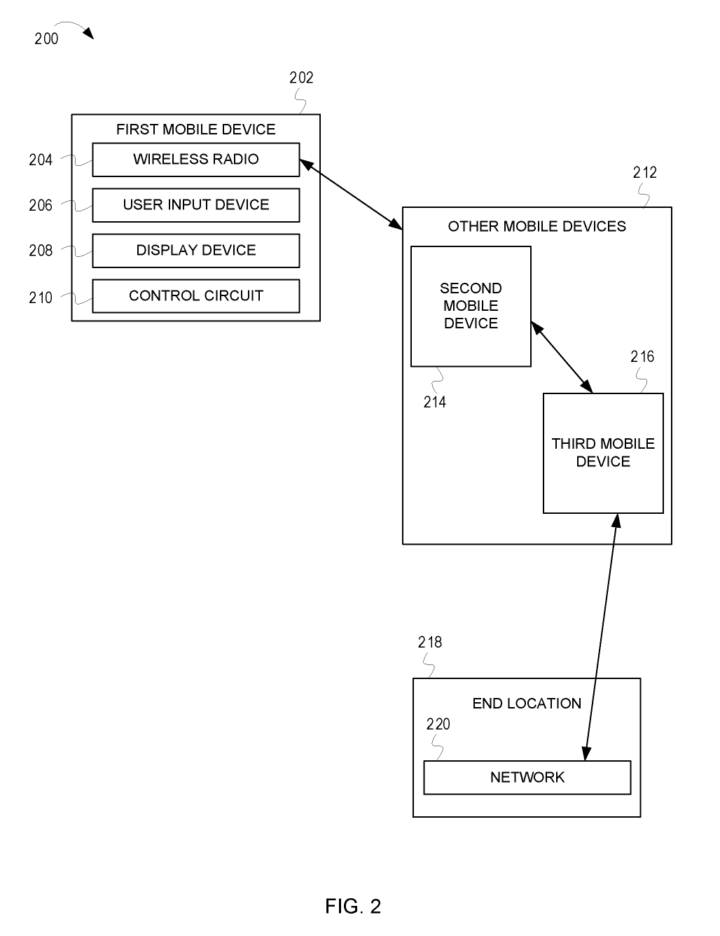

While the discussion of FIG. 1 provides background information regarding transmission of data in a peer-to-peer manner to make use of a free wireless network provided at an end location, the discussion of FIG. 2 provides additional details regarding such a system.

FIG. 2 is a block diagram of a system 200 for transmitting data from a first mobile device 202 in a peer-to-peer manner to make use of a free wireless network 220 at an end location 218, according to some embodiments. The system 200 includes a first mobile device 202, other mobile devices 212, and an end location 218. The first mobile device 202 includes a wireless radio 204, a user input device 206, a display device 208, and a control circuit 210.

The control circuit 210 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 210 is configured (for example, by using corresponding programming as will be well understood by those skilled in the art) to carry out one or more of the steps, actions, and/or functions described herein.

By one optional approach the control circuit 210 operably couples to a memory. The memory may be integral to the control circuit 210 or can be physically discrete (in whole or in part) from the control circuit 210 as desired. This memory can also be local with respect to the control circuit 210 (where, for example, both share a common circuit board, chassis, power supply, and/or housing) or can be partially or wholly remote with respect to the control circuit 210 (where, for example, the memory is physically located in another facility, metropolitan area, or even country as compared to the control circuit 210).

This memory can serve, for example, to non-transitorily store the computer instructions that, when executed by the control circuit 210, cause the control circuit 210 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 210 is configured to perform operations for transmitting data in a peer-to-peer manner to an end location 218 predicted to have free Wi-Fi. The control circuit 210 receives a command, via the user input device 206, to transmit the data. The user input device 206 can take any suitable form, such as a touchscreen, touchpad, keyboard, trackball, etc. In response, the control circuit selects and end location 218 predicted (as used herein, the term “predicted” may also indicate that the end location 218 is known) to have free Wi-Fi. After selecting the end location 218, the control circuit 210 transmits a discovery message. The control circuit transmits the discovery message via the wireless radio 204. The discovery message seeks other mobile devices 212 in proximity to the first mobile device 202 through which data can pass on its journey to the end location 218. At least some of the other mobile devices 212 receiving the discovery message respond to the first mobile device 202. The control circuit selects at least one of the other mobile devices 212 and transmits the data to the at least one of the other mobile devices 212.

The other mobile devices 212 (i.e., a second mobile device 214 and a third mobile device 216) continue the process until the data is received by a mobile device that has access to a network 220 at the end location 218 (i.e., the third mobile device 216 in the example depicted in FIG. 2). Although the example depicted in FIG. 2 includes only two mobile devices in addition to the first mobile device 202, in practice the data is likely to be transmitted via more than two other mobile device 212. Once the third mobile device 216 receives the data, the third mobile device 216 transmits the data via the free wireless network 220. In some embodiments, the third mobile device 216 can transmit a confirmation message once the data has been transmitted over the network 220. For example, the third mobile device 216 can transmit the confirmation message to the mobile device from which the third mobile device 216 received the data (and so on and so forth back to the first mobile device 202). Alternatively, or additionally in case a mobile device is no longer reachable, the third mobile device 216 (or any other mobile device in the chain) can select a mobile device on a path toward the first mobile device 202, similar to how the first mobile device 202 selected the end location.

Additionally, in some embodiments, any of the other mobile devices 212 can transmit error messages should an error occur. For example, if the third mobile device 216 is not able to transmit the data via the network 220, the third mobile device 216 can transmit an error message. Similarly, if the second mobile device 214 is not able to find a next mobile device, the second mobile device 214 can transmit an error message.

In some embodiments, the first mobile device 202 can attempt to retransmit the discovery message and/or the data. For example, if the first mobile device 202 receives an error message, the first mobile device 202 can retransmit he discovery message and/or the data. Similarly, other mobile device along the chain (e.g., the second mobile device 214) can attempt to retransmit the discovery message and/or the data. Additionally, in some embodiments, the first mobile device 202, or any other mobile devices, can retransmit the discovery message and/or data in the event that a confirmation is not received after a specified time period.

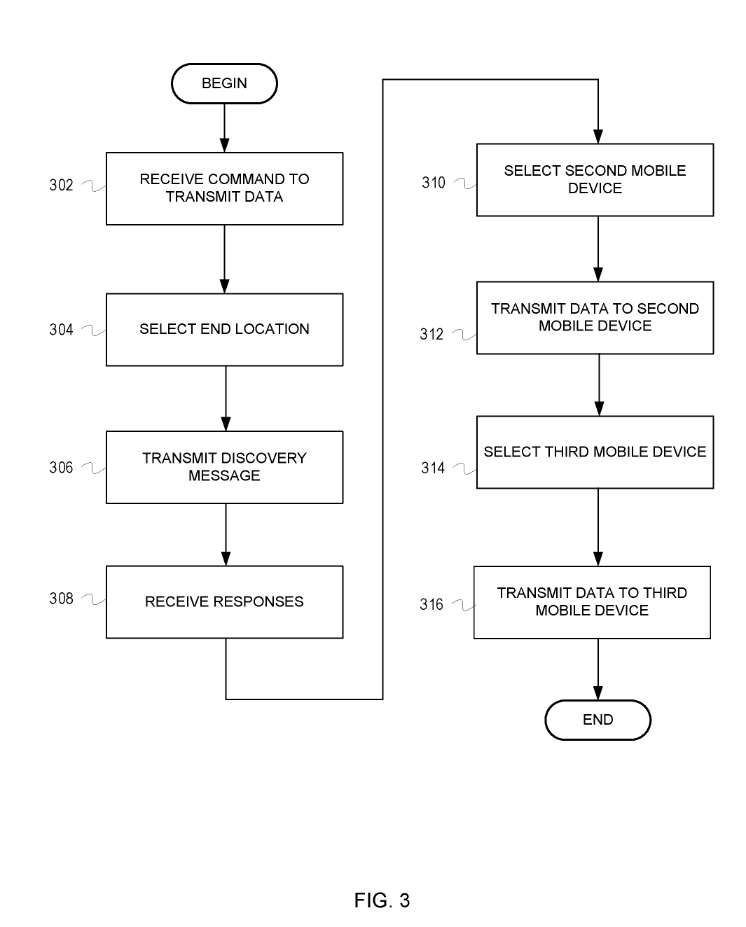

While the discussion of FIG. 2 provides additional detail regarding a system for the transmission of data in a peer-to-peer manner to make use of a free wireless network provided at an end location, the discussion of FIG. 3 provides example operations for transmitting data from a first mobile device to an end location in a peer-to-peer manner.

FIG. 3 is a flow chart depicting example operations for transmitting data from a first mobile device to an end location in a peer-to-peer manner, according to some embodiments. The flow begins at block 302.

At block 302, a command to transmit data is received. For example, a control circuit of a first mobile device can receive the command to transmit data. The control circuit can receive the command tom transmit data via a user input device. The command instructs the mobile device to transmit the data in a peer-to-peer manner until the data reaches and end location at which the data can be transmitted over a wireless network. The flow continues at block 304.

At block 304, an end location is selected. For example, the control circuit selects the end location. In some embodiments, the control circuit selects the end location based on information received from an application executing on the mobile device. As one example, the application can be a mapping application. In such embodiments, the control circuit can select the end location from points of interest provided by the mapping application. The control circuit can analyze the point of interest and predict which of the points of interest is likely to have provide Wi-Fi. For example, the control circuit may assume that certain types of establishments, such as fast food restaurants, are likely to provide free Wi-Fi. The control circuit can also base the selection on the location of the points of interest and the location of the mobile device. Additionally, or alternatively, the application can include a list of location known to provide free Wi-Fi. In such embodiments, the control circuit can simply pick an end location based on location without a prediction required. The flow continues at block 306.

At block 306, a discovery message is transmitted. For example, the control circuit can transmit the discovery message via a wireless radio of the mobile device. The discovery message is a one-to-many message designed to determine if any other mobiles devices are within range of the mobile device. Additionally, the mobile device inquires as to locations of the other mobile devices. The discovery message can be a simple request for locations of other mobile devices, or can include additional information, such as the data to be transmitted, or information about the data to be transmitted. The flow continues at block 308.

At block 308, responses are received. For example, the control circuit can receive the responses from at least some of the other mobile devices via the wireless radio of the mobile device. The responses indicate the willingness (e.g., based on user privacy settings and functionality) of the other mobile devices to transmit the data. The responses also include location information for the other mobile devices. The flow continues at block 310.

At block 310, a second mobile device is selected. For example, the control circuit can select the second mobile device (i.e., a next mobile device) from the other mobile devices from which responses were received. In some embodiments, the control circuit selects the second mobile device based on the location information for the second mobile device. For example, the second mobile device may be the nearest to the end location of all of the other mobile devices from which responses were received. The flow continues at block 312.

At block 312, the data is transmitted to the second mobile device. For example, the control circuit can transmit the data to the second mobile device via the wireless radio. In some embodiments, the control circuit transmits information in addition to the data. For example, the control circuit can transmit an indication of the end location, information about the data, indications of other mobile device to which the data should be transmitted, etc. The flow continues at block 314.

At block 314, a third mobile device is selected. For example, the second mobile device can select the third mobile device. The second mobile device can select the third mobile device in a manner similar to which the mobile device selected the second mobile device. That is, the second mobile device can transmit discovery messages and, based on the responses receive, select the third mobile device. The flow continues at block 316.

At block 316, the data is transmitted to the third mobile device. For example, the second mobile device can transmit the data to the third mobile device. The above-noted process continues until the data reaches the end location (i.e., a mobile device connected to a wireless network provided at the end location). If the third mobile device is not connected to a wireless network at the end location, the third mobile device seeks a fourth mobile device to which to transmit the data. If the third mobile device is connected to a wireless network at the end location, the third mobile device transmits the data via the wireless network at the end location.

In some embodiments, a system for transmitting data from a first mobile device to an end location in a peer-to-peer manner comprises the first mobile device, wherein the first mobile device comprises a wireless radio, wherein the wireless radio is configured to transmit and receive data, a user input device, a display device, and a control circuit, wherein the control circuit is configured to receive, via the user input device, a user command to transmit data, select, based on information received from an application executing on the first mobile device, the end location, wherein the end location is predicted to provide access to a wireless local area network, wherein the wireless local area network is communicatively coupled to a wide area network, and wherein the access to the wireless local area network is provided without requiring payment for use of the local area network, transmit, via the wireless radio to other mobile device, a discovery message, receive, from at least some of the other mobile devices, responses, wherein the responses include location information for the at least some of the other mobile devices, select, from the other mobile device based on the end location and the location information for the at least some of the other mobile devices, a second mobile device, and transmit, to the second mobile device via the wireless radio, the data, and the second mobile device, wherein the second mobile device is configured to select, based on the end location after receipt of the data from the first mobile device, a third mobile device, and transmit, to the third mobile device, the data.

In some embodiments, an apparatus and a corresponding method performed by the apparatus comprises receiving, via a user input device of a first mobile device, a command to transmit data from the first mobile device, selecting, by the first mobile device based on information received from an application executing on the first mobile device, the end location, wherein the end location is predicted to have free Wi-Fi access, transmitting, by the first mobile device via a wireless radio to other mobile devices, a discovery message, receiving, at the first from at least some of the other mobile devices, responses, wherein the responses include location information for the at least some of the other mobile devices, selecting, by the first mobile device from the other mobile devices based on the end location and the location for the at least some of the other mobile devices, a second mobile device, transmitting, by the first mobile device to the second mobile device, the data, selecting, by the second mobile device based on the end location after receipt of the data from the first mobile device, a third mobile device, and transmitting, by the second mobile device to the third mobile device, the data.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for transmitting data from a first mobile device to an end location in a peer-to-peer manner, the system comprising:
the first mobile device, wherein the first mobile device comprises:
a wireless radio, wherein the wireless radio is configured to transmit and receive data;
a user input device;
a display device; and
a control circuit, wherein the control circuit is configured to:
receive, via the user input device, a user command to transmit data;
select, based on information received from an application executing on the first mobile device, the end location, wherein the end location is predicted to provide access to a wireless local area network, wherein the wireless local area network is communicatively coupled to a wide area network, and wherein the access to the wireless local area network is provided without requiring payment for use of the wireless local area network;
transmit, via the wireless radio to other mobile devices, a discovery message;
receive, from at least some of the other mobile devices, responses, wherein the responses include location information for the at least some of the other mobile devices;
select, from the other mobile devices based on the end location and the location information for the at least some of the other mobile devices, a second mobile device; and
transmit, to the second mobile device via the wireless radio, the data; and
the second mobile device, wherein the second mobile device is configured to:
select, based on the end location after receipt of the data from the first mobile device, a third mobile device; and
transmit, to the third mobile device, the data.

2. The system of claim 1, wherein the application executing on the includes a list of locations known to have free Wi-Fi.

3. The system of claim 1, wherein the application executing on the first mobile device is a mapping application.

4. The system of claim 1, wherein the end location is selected based on types of establishments at the end location.

5. The system of claim 4, wherein the types of establishments include one or more of a restaurant, a retail facility, a publicly owned facility, and an educational facility.

6. The system of claim 1, wherein the second mobile device is closer to the end location than each of the at least some of the other mobile devices.

7. The system of claim 1, wherein the system further comprises:
the third mobile device, wherein the third mobile device is communicatively coupled to the Wi-Fi access at the end location, the third mobile device configured to:
receive, from the second mobile device, the data; and
transmit, via the Wi-Fi access at the end location, the data.

8. The system of claim 7, wherein the third mobile device is further configured to:
generate a confirmation message; and
transmit, to a mobile device, the confirmation message.

9. The system of claim 8, wherein the third mobile device transmits the confirmation message to the second mobile device.

10. A method for transmitting data from a first mobile device to an end location in a peer-to-peer manner, the method comprising:
receiving, via a user input device of the first mobile device, a command to transmit data from the first mobile device;
selecting, by the first mobile device based on information received from an application executing on the first mobile device, the end location, wherein the end location is predicted to have free Wi-Fi access;
transmitting, by the first mobile device via a wireless radio to other mobile devices, a discovery message;
receiving, at the first mobile device from at least some of the other mobile devices, responses, wherein the responses include location information for the at least some of the other mobile devices;
selecting, by the first mobile device from the other mobile devices based on the end location and the location information for the at least some of the other mobile devices, a second mobile device;
transmitting, by the first mobile device to the second mobile device, the data;
selecting, by the second mobile device based on the end location after receipt of the data from the first mobile device, a third mobile device; and
transmitting, by the second mobile device to the third mobile device, the data.

11. The method of claim 10, wherein the application executing on the includes a list of locations known to have free Wi-Fi.

12. The method of claim 10, wherein the application executing on the first mobile device is a mapping application.

13. The method of claim 10, wherein the end location is selected based on types of establishments at the end location.

14. The method of claim 13, wherein the types of establishments include one or more of a restaurant, a retail facility, a publicly owned facility, and an educational facility.

15. The method of claim 10, wherein the second mobile device is closer to the end location than each of the at least some of the other mobile devices.

16. The method of claim 10, further comprising:
receiving, by the third mobile device from the second mobile device, the data and
transmitting, via the Wi-Fi access at the end location, the data.

17. The method of claim 16, further comprising:
generating, by the third mobile device, a confirmation message; and
transmitting, to a mobile device, the confirmation message.

18. The method of claim 17, wherein the third mobile device transmits the confirmation message to the second mobile device.
